(19) United States
(12) Patent Application Publication
(10) Pub. No.: US 2026/0256187 A1
(43) Pub. Date: Sep. 3, 2026

(54) Aerosol-Generating Article, Device and System

(71) Applicant: JT International SA, Geneva (CH)

(72) Inventor: Cecile Sinkinson, Versonnex (FR)

(73) Assignee: JT International SA, Geneva (CH)

(21) Appl. No.: 19/491,212

(22) PCT Filed: Sep. 25, 2024
(86) PCT No.: PCT/EP2024/076952

§ 371 Date: Dec. 8, 2025

(30) Foreign Application Priority Data
Sep. 26, 2023 (EP) 23199713.1

(51) Int. Cl. A24D 1/02; A24B 15/34; A24D 1/00; A24D 1/20; A24D 3/04; A24D 3/17; A24F 40/20; H05B 3/02

(52) U.S. Cl. CPC A24D 1/025; A24B 15/34; A24D 1/002; A24D 1/20; A24D 3/048; A24D 3/17; A24F 40/20; H05B 3/02

(57) ABSTRACT

An aerosol-generating article (10) comprises a first segment (12) located at a mouth end; a second segment (16) comprising an aerosol generating substrate, and located upstream of the first segment (12); optionally a third segment (18) comprising a filter material, and located upstream of the second segment (16); a cooling agent applied to at least a part of an outer surface of a tipping paper and/or impregnated into the filter material of the third segment (18) and/or applied to at least a part of an outer surface of the filter material of the third segment (18), and a flavouring agent applied to the aerosol-generating substrate, said flavouring agent comprising menthol. An aerosol-generating device is adapted to receive at least a part of such an article (10), and an aerosol-generating system comprises the device and the article (10).

### TECHNICAL FIELD

The present invention relates to an aerosol-generating article, an aerosol-generating device and an aerosol-generating system.

### BACKGROUND

Heat-not-burn (HNB) devices that use heated tobacco sticks (HTS) have become increasingly popular over known ready-made-cigarettes and combustible tobacco products. In such devices, the tobacco consumable/article is inserted into a heating chamber to be heated so as to generate an inhalable aerosol during a vaping session.

To enhance user experience, hts often comprise additional flavouring agents. Menthol is traditionally used to provide a refreshing sensation. However, there are several disadvantages with menthol including the high volatility inducing strong odour, potential irritation, the bitter taste, and its relatively short-lasting effect. Cooling agents can instead be used as effective alternatives to menthol for providing a cooling sensation without the associated disadvantages. Their cooling sensation builds gradually and lasts longer than the refreshing sensation usually provided by the menthol.

In this context, WO 2021/260372 A1 describes a tobacco article comprising a flavourant and/or a cooling agent in the aerosolizable material, in combination with a basic solution contained in a capsule which may be embedded in filter material to promote the formation of nicotine free base when the basic solution contacts the aerosolizable material.

In another example, WO 2018/215781 A1 describes a tobacco-containing consumable article for use in aerosol-generating devices comprising at least a tobacco-derived portion, a distal filter portion and a mouth-end filter portion held together in a continuous overwrap. Flavours can be added to the tobacco-derived portion.

Finally, according to EP 2 844 094 B1, a cooling agent trapped within an inclusion complex, such as a cyclodextrin inclusion complex, is disposed on a tipping paper of the smoking article. The cyclodextrin inclusion complex improve the stability of the cooling agent as it helps in avoiding the migration of the cooling agent from the surface on which it is disposed.

### SUMMARY OF THE INVENTION

In view of the above, it is an object of the present invention to provide an aerosol-generating article, device and system configured or designed to deliver an improved sensory experience to users thereof.

This is achieved by means of the article described in claim 1 as well as the device according to claim 15, with which the article can be used, as well as the combination of the device and the article, in accordance with the system defined in claim 16.

Accordingly, the article has a first segment located at a mouth end and a second segment comprising an aerosol-generating substrate and located upstream of the first segment. Optionally, a third segment, for example but not necessarily comprising filter material, and located upstream of the second segment is provided. The inventors surprisingly found out through experimental sensory panels that sensory experience can be significantly improved by applying, such as by coating or spraying, a cooling agent to at least a part of an outer surface of a tipping paper, and applying a flavouring agent comprising menthol to the aerosol-generating substrate. The tipping paper is typically wrapped around at least a part of the first segment, and preferably also at least a part of the second segment and typically constitutes the outermost wrapper of the article. The tipping paper can, but not necessarily has to, extend to the most downstream end of the first segment, but is arranged to be contacted by the lips of the user. The aerosol generating article of the invention advantageously provides a more lasting and satisfying cooling sensation throughout an entire vaping session. At the beginning of the vaping session, menthol contained in the aerosol generating substrate provides a natural cooling sensation to the user from the inhaled aerosol being generated upon heating of the aerosol generating material, which cooling sensation is further supported and prolonged until the end of the vaping session by the cooling agent provided on the tipping paper, in particular from the middle of the session after the menthol-generated refreshing sensation has vanished.,

If the mentioned third segment is present, a cooling agent can alternatively or additionally be impregnated into the material thereof, and/or it can be applied to at least a part of an outer surface of the material forming said third segment. In this case, since the third segment is typically not heated directly, any cooling agent impregnated into this filter material and/or applied to the outer surface of the filter material will be released slowly throughout the entire vaping session. This has the advantageous consequence, that throughout the vaping session, a cooling sensation is experienced by the user and has been perceived particularly well in experimental consumer tests. In this context, at least during parts of the vaping session, the mentioned effects of menthol/cooling agent being released synergistically provide refreshing and cooling sensations preferred by the users. In particular, combinations of menthol and cooling agents and also combinations of menthol with a mix of cooling agents have been studied and found to impart a perceived high intensity and long-lasting cooling sensation.

In this context, at least two, preferably, when present, all three (or four, see the cooling segment below) segments can be cylindrical and aligned in an axial direction. The terms up-and downstream refer to the flow direction of air and aerosol in use, i.e. when a user inhales applying negative pressure at the mouth end of the aerosol-generating article.

The aerosol generating substrate may comprise any type of solid or semi-solid material. Example types of aerosol generating solids include powder, granules, pellets, shreds, strands, particles, gel, strips, loose leaves, cut filler, porous material, foam material or sheets. The aerosol generating substrate may comprise plant derived material and in particular, may comprise tobacco, botanicals, or a combination thereof. It may comprise reconstituted tobacco, for example including tobacco and any one or more of cellulose fibres, tobacco stems ad tobacco stalk fibres and inorganic fillers such as CaCO₃, as well as binders. The reconstituted tobacco may comprise tobacco sheets of any kind (paper-like sheets, cast tobacco sheets, corrugated sheets, etc.) in full sheets being crimped, folded and/or rolled or sheet fragments, and in an orientated gathered form (e.g., parallel arrangement or weaved pattern of substantially identical sheet fragments) or in randomly arranged form (e.g., sheet fragments of various sizes and shapes in bulk mixed form as tobacco cut filler). The aerosol-generating substrate may also be a foam or mousse. For the sake of good order, it should be mentioned that the article described herein shall not be burnt, but only heated in order to produce an inhalable aerosol.

Preferred embodiments are described in the further claims.

As regards the amount of cooling agent applied to the tipping paper and/or the outer surface of the material of the third segment, if present, an amount of 0.5 to 1.2 grams per square meter (gsm), preferably 0.7 to 0.8, more preferably 0.75 to 0.76 and most preferred about 0.756 has turned out to be optimal in consumer tests.

The amount of menthol contained in the aerosol-generating substrate is preferably within a range of 0.10 to 0.60 wt % based on the total weight of the aerosol generating substrate. In a preferred embodiment according to the present invention, the amount of menthol contained in the aerosol-generating substrate is ranging from 0.10 to 0.25 wt %, preferably 0.12 to 0.20 wt %, more preferably 0.15 to 0.20 wt %, most preferred about 0.18 wt % based on the total weight of the aerosol generating substrate. In another preferred embodiment, the amount of menthol contained in the aerosol-generating substrate is ranging from 0.26 wt % to 0.60 wt %, preferably from 0.30 wt % to 0.60 wt %, preferably from 0.35 wt % to 0.60 wt %, preferably from 0.40 wt % to 0.60 wt %, preferably from 0.45 wt % to 0.60 wt%, more preferably from 0.45 wt % to 0.57 wt %, most preferred about 0.47 wt % based on the total weight of the aerosol generating substrate.

The material provided in the third segment can be a gathered paper sheet, such as used for paper filters.

In particular, an efficiently producible paper based third segment can be formed of crimped paper sheet material having a basis weight ranging from 20 to 50 gsm.

As already detailed above, the aerosol-generating substrate may contain tobacco, botanicals (e.g. non-tobacco plant materials such as tea, rooibos, eucalyptus or the like), or a combination thereof.

The first segment at the mouth end may advantageously comprise a filter material, which preferably comprises cellulose acetate, paper, or a non-woven cellulose-based material. The length of the filter segment in the longitudinal direction of the article can be appropriately adjusted in accordance with the size of the article itself.

In practice, for a 50 to 70 mm long article the filter segment is usually not less than 5 mm long but not more than 35 mm long, preferably between 10 mm and 20 mm. Likewise the cross-sectional shape of the part of filter is substantially circular, and the diameter of the filter segment cross-section is usually between 4 mm and 9 mm, preferably between 5 mm and 8 mm. The circumference of the filter segment, like that of the article, is usually 14 mm to 27 mm, preferably 16 mm to 25 mm. The resistance to draw or pressure drop of the first segment, which is a filter segment, per 120 mm length of the filter segment in the longitudinal direction of the segment is not particularly limited but is usually not less than 40 mmH2O and not more than 300 mmH2O, preferably between 70 mmH2O and 280 mmH2O still preferably between 90 mmH2O and 260 mmH2O. The resistance to draw or pressure drop is measured according to the ISO standard method (ISO6565) as well-known in the tobacco industry.

In order to decrease the temperature of the generated aerosol such that it has a temperature suitable for the aerosol to enter a user's mouth, a cooling segment can be provided between the first and the second segment, and can, for example, consist of a paper or cardboard tube, as well-known in the art. The cooling segment preferably has no or very little pressure drop and is preferably provided with perforations for introducing air in the paper tube to admix with the vapor generated from the aerosol generating substrate in use to form an aerosol inhalable by a user. The length of the paper tube is usually comprised between 10 mm and 30 mm, and preferably about 20 mm.

In embodiments, a further intermediate centre hole segment of may be arranged between the first segment and the cooling segment. That centre hole intermediate segment may be formed of high density cellulose acetate material hardened by plasticizer such as triacetine and has the function of increasing the strength of the first (mouthpiece) segment while not increasing its pressure drop to provide an optimal vaping experience and sensory delivery. The center hole segment and the filter segment may be connected by a filter wrapper to form a mouthpiece part or first segment of the aerosol generating article.

Further, the second, aerosol generating substrate containing, segment, the cooling segment, and eventual third front plug segment may be connected by standard cigarette wrapper to form an aerosol generating rod part of the article. The aerosol generating rod part is connected to the mouthpiece part by means of the tipping paper in a known fashion.

In order to ensure the cooling effect of the cooling agent applied to the tipping paper, this can be applied at least in an area from 5 mm from the mouth end of the article. In other words, up to 5 mm from the very end of the article may be free of cooling agent. Alternatively or additionally, the cooling agent can be applied up to 15 mm, preferably 10 mm from the mouth end of the article. These ranges ensure that the cooling effect is sensed by the user. It is currently most preferred to apply the cooling agent starting at the very mouth end and within a distance of 10 mm from the mouth end.

Whereas the article described herein can have any cross-sectional shape, a cylindrical shape is currently preferred in line with the user's preferences.

As regards the actual cooling agent, a cooling agent other than menthol may be used and WS5 is currently preferred, but other cooling agents mentioned in claim 14 can also be applied either alone or in combination. In this context, suitable cooling agents for the purpose of the present invention include: Cyclohexanecarboxamide, N-Ethyl-5-Methyl-2-(1-Methylethyl), otherwise known as WS-3; N-(Ethoxycarbonylmethyl)-3-p-menthanecarboxamide, otherwise known as WS-5; (1R, 2S, 5R)-N-(4-Methoxyphenyl)-5-methyl-2-(1-methylethyl) cyclohexanecarboxamide, otherwise known as WS-12; Butanamide, N,2,3-trimethyl-2-(1-methylethyl), otherwise known as WS-23; (N-Ethyl-2,2-diisopropylbutanamide, otherwise known as WS-27; 1-[(1R, 2R, 4R)-2-hydroxy-4-methylcyclohexyl]ethanone, otherwise known as Coolact HK, and N-(2-Hydroxy-2-phenylethyl)-2-isopropyl-5,5-dimethylcyclohexane-1-carboxamide), otherwise known as Coolact 370. Cooling agents or coolants to be used with menthol include a wide variety of materials such as carboxamides, ketals, diols, menthyl esters and mixtures thereof. Examples of coolants are the paramenthan carboxamide agents such as N-ethyl-p-menthan-3-carboxamide, known commercially as “WS-3”, N,2,3-trimethyl-2-isopropylbutanamide, known as, “WS-23”, and others in the series such as WS-5, WS-11, WS-12, WS-14, WS-27 and WS-30. Additional suitable coolants include 3-1-menthoxypropane-1,2-diol known as TK-10 manufactured by Takasago; menthone glycerol acetal known as MGA; menthyl esthers such as menthyl acetate, menthyl acetoacetate, menthyl lactate known as Frescolato supplied by Haarmann and Reimer, and monomenthyl succinate under the tradename Physcool from V. Manė. The terms menthol and menthyl as used herein include dextro-and levorotatory isomers of these compounds and racemic mixtures thereof.

As already indicated above, the article described herein can particularly be used together with an aerosol-generating device adapted to receive at least a part of the article in a heating chamber thereof, the device further comprising a heating element configured to heat the article and a power supply configured to supply power to the heating element.

Finally, a complete system comprises both the device and the article.

### BRIEF DESCRIPTION OF THE DRAWINGS

Hereinafter, the invention will be further described with reference to a preferred embodiment thereof, in which

FIG. 1 shows a schematic perspective view of a first embodiment of an aerosol generating article according to the invention in relation to a heater assembly of an aerosol generating device to use with the article,

FIG. 2 shows a schematic perspective view of a second embodiment of an aerosol generating article according to the invention in relation to a heater assembly of an aerosol generating device to use with the article,

FIG. 3 shows a schematic perspective view of a third embodiment of an aerosol generating article according to the invention in relation to a heater assembly of an aerosol generating device to use with the article,

FIG. 4 shows a schematic perspective view of a fourth embodiment of an aerosol generating article according to the invention in relation to a heater assembly of an aerosol generating device to use with the article,

FIGS. 5 to 10 show schematic cut views of further embodiments of an aerosol generating article according to the invention or part thereof,

FIG. 11 shows a schematic view of the system according to the invention,

FIG. 12 shows typical evolution of the cooling sensation felt by users during a typical vaping session over time, and

FIG. 13 shows the cooling sensation over time for an aerosol generating article in accordance with the invention compared with a similar article not in accordance with the invention.

### DETAILED DESCRIPTION OF PREFERRED EMBODIMENTS

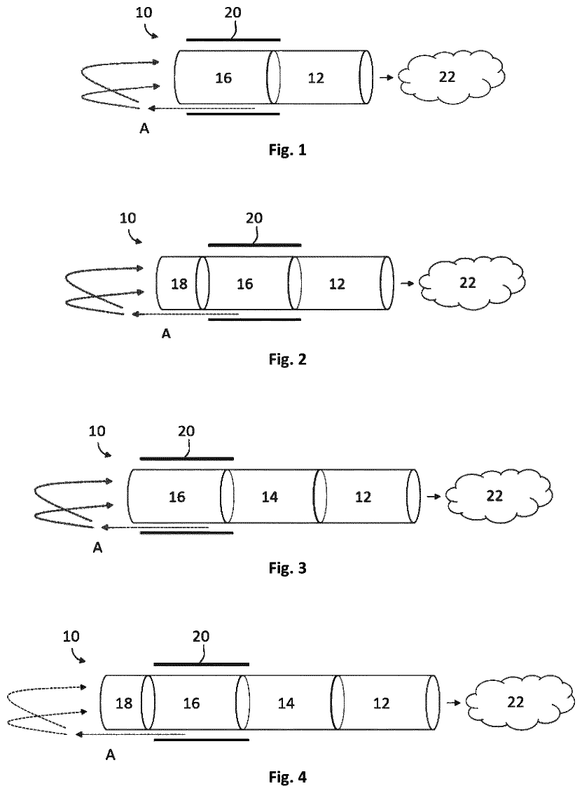

As can be seen in FIG. 1, the aerosol generating article 10 according to the invention has, in a first embodiment shown, a first segment 12 located at a mouth end, thus forming a mouthpiece segment or part of the article, and a second segment 16 located upstream of the first segment and comprising an aerosol-generating substrate as well as menthol.

The aerosol generating substrate may comprise a plant filling material comprising tobacco material, botanicals, or a combination thereof. When comprising tobacco material, the latter may comprise lamina and/or stems. It may also alternatively or in combination comprise reconstituted tobacco sheet materials formed of dry tobacco leaves in particulate form so as to have a mean particle size of 20 μm or more but not more than 200 μm, which is then homogenized into a sheet-processed material. The aerosol generating substrate content is typically of between about 200 mg and 800 mg, preferably between 250 and 350 mg for a 20 mm length and 22 mm circumference of the second segment 16.

Various kinds of tobacco leaves can be used for making a tobacco containing aerosol generating substrate to achieve the desired taste. Details of tobacco varieties that can typically be used are described in “Tobacco Encyclopedia, Tobacco comprehensive research Center, 2009.3.31”, as well as various known processes available to the skilled person to form homogenized sheets of tobacco therefrom to achieve reconstituted tobacco sheets used as aerosol generating substrates.

In addition, the aerosol generating substrate may preferably comprise an aerosol former such as Glycerine, Propylene Glycol, triacetin, 1,3-butanediol and blends thereof in weight contents of between about 5 wt. % or more, preferably 10 wt. % or more, usually 50 wt. % or less, preferably 15 wt. % or more and 25 wt. % or less based on the total amount of the filling material.

The first and segment segments 12, 16 are joined in an end-to-end configuration along a longitudinal direction of the article by means of a tipping paper (not represented). A cooling agent is applied to the tipping paper on the outside of the first segment 12.

In use, the aerosol generating article is inserted in the heating chamber or cavity of an aerosol generating device comprising a heating element, depicted by reference 20 in FIG. 1 to 5. The heating element 20 is indicated to surround the second segment 16 so as to heat same and cause the production of an aerosol. The heating element 20 is substantially as long, in an axial direction, as the second segment 16, but can also be slightly shorter.

As indicated by arrows A, when negative pressure is applied by the user at the mouth end, air is drawn into the article 10 and flows through the aerosol-generating substrate in the second segment 16 so that aerosol containing menthol is released. The generated aerosol flows through the first segment 12 and can be inhaled as an aerosol 22 indicated in the drawing. In other words, menthol can immediately be sensed by the user. Along the vaping session, the cooling agent applied to the tipping paper is also sensed and, in synergy with the menthol, provides a pleasant refreshing and cooling experience.

The embodiment of FIG. 2 additionally comprises a third segment 18, forming a front plug of the article 10. The front plug 18 may be comprising a filter material and is located upstream of the second segment 16. As indicated above, the third segment 18 is optional, but present in the embodiment shown in FIG. 2. A cooling agent can be applied to at least a part of an outer surface of the filter material of the third segment 18 and/or impregnated into the filter material of the third segment 18. This cooling agent is released in use by the third segment 18 and also contributes to the described refreshing or cooling effect.

The embodiment of FIG. 3 additionally comprises, as compared to the embodiment of FIG. 1, a paper tube constituting a cooling segment 14 upstream of the first segment 12.

The embodiment of FIG. 4 also comprises this cooling segment 14 as well as the third segment 18, upstream of the second segment 16 as already shown in FIG. 2.

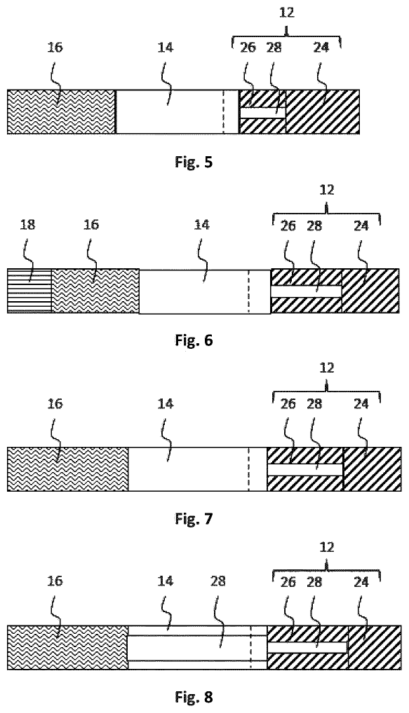

In the embodiments shown, the cooling segment 14 and the first segment 12 can be substantially of equal length and slightly longer than the second segment 16. This is, however, merely one of a plurality of conceivable embodiments. In particular, further embodiments and variants are shown in and described with reference to FIGS. 5 to 8. Finally, in the embodiments shown in FIGS. 2 and 4, the third segment 18 can be approximately of half the length of the second segment 16, or slightly shorter. The third segment 18, can be an acetate or paper filter can have a length ranging from 4 to 8 mm, most preferably 6 mm. The second segment 16 can have a length ranging from 10 to 35 mm, preferably 12 to 15 mm, most preferably 15 mm. The cooling segment 14, which can comprise a paper tube can have a length ranging from 8 mm to 20 mm, most preferably 20 mm. The first segment 12 can have a length ranging from 10 to 35 mm, preferably 12 to 20 mm, most preferably 20 mm. In addition to or instead of the cooling segment a centre hole can be provided in the first segment 12 along at least a part of its length, thus with a length ranging from 8 to 20 mm, most preferably 20 mm.

FIG. 5 shows a further embodiment based on that of FIG. 3. In particular, the first segment 12 is separated into a filter plug 24, which can be an acetate or paper filter, and a centre hole segment 26 having a longitudinal bore 28.

This structure of the first segment 12 is also applicable to the embodiment of FIG. 4 as shown in FIG. 6. Further, as compared to the embodiment of FIG. 5, the filter segment 26 is longer in the axial direction, approximately one and a half times as long as the filter plug 24, whereas it is approximately the other way around in the embodiment of FIG. 5. For the sake of completeness, reference is made to preferred lengths of the various segments mentioned above. In particular, the first segment 12 can range from 15 to 25 mm most preferably 20 mm, and the centre hole can range from 6 to 18 mm most preferably 8 to 12 mm, most preferably 12 mm. the filter segment 26 of FIG. 6 and for example have a length of 12 mm, and the filter plug of the same embodiment can have a length of 8 mm. A so-called mono acetate filter plug 24 can range from 7 to 20 mm most preferably 8 mm.

FIG. 7 shows another variant, in which the structure of filter plug 24 and centre hole segment 26 of FIG. 6 is applied to the overall structure of FIG. 5.

FIG. 8 shows a further alternative, in which the cooling segment 14 has a longitudinally extending bore 28 somewhat smaller than that of the embodiments of FIGS. 5 to 7, but still larger than that of the centre hole segment 26 shown for all the embodiments of FIGS. 5 to 7. The latter center hole extends approximately ¼ to ⅓ across the diameter, whereas the bore 28 of the cooling segment 14 extends across approximately 50 to 70% across the diameter.

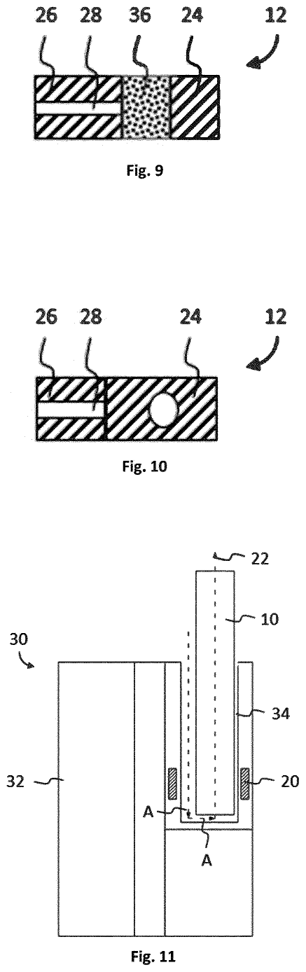

Moreover, the filter plug 24 can also have a charcoal section 36 as shown in FIG. 9, which can have a length of 7 mm, and an additive release container (for example, a capsule) formed of a crushable outer shell enclosing a liquid or particulate additive to be released in the filter plug to impart a particular sensory attribute to aerosol in use (e.g. a flavour or filtering additive). Such additive release container may be of the kind described in WO 2023/281230 A1 or EP 1906775 B1.

FIG. 11 shows the aerosol generating system 30 of the invention comprising an aerosol generating article 10 in one of the above-mentioned embodiments and an aerosol generating device 32. As can be taken from FIG. 11, the device 32 comprises a heating chamber 34 configured to receive the article 10. In the embodiment shown, a heating element 20, which is also visible in FIGS. 1 to 4, is provided near the bottom of the chamber 34. The heating element 20 can for example be a resistance heating element or a coil cooperating with a susceptor within the article 10. Although not detailed in the drawing, the device 32 further comprises a power supply configured to supply power to the heating element 20, such as a battery, as well as any suitable control, display and/or operating means such as knobs for actuating the device 32.

Moreover, as shown by the arrows A, the device is adapted to allow air to flow to the bottom or device end of the article 10. The air then flows through the article and starting in the aerosol generating substrate of the second segment 16 as shown in FIGS. 1 to 8, aerosol flows out of the end of the article 10 opposite the device 32 so as to be inhalable by a user.

In one embodiment of the invention the aerosol-generating article (10) comprises:
a first segment (12) located at a mouth end;
a second segment (16) comprising an aerosol generating substrate, and located upstream of the first segment (12);
optionally a third segment (18) for example comprising filter material, and located upstream of the second segment (16);
a cooling agent applied to at least a part of an outer surface of a tipping paper and/or impregnated into the filter material of the third segment (18) and/or applied to at least a part of an outer surface of the filter material of the third segment (18),
wherein the cooling agent is one or more selected from the group consisting of ethyl 2-[[(1R,2S,5R)-5-methyl-2-propan-2-ylcyclohexanecarbonyl]amino]acetate (CAS 68489-14-5; trade name: WS-5), N-ethyl-2-(isopropyl)-5-methylcyclohexanecarboxamide (CAS 39711-79-0; trade name: WS-3), and N-(2-hydroxy-2-phenylethyl)-2-isopropyl-5,5-dimethylcyclohexane-1-carboxamide (CAS 2186611-08-3; trade name: Coolact® 370) ;
and a flavouring agent applied to the aerosol-generating substrate, said flavouring agent comprising menthol.

In this embodiment, the cooling agent is preferably selected from the group consisting of ethyl 2-[[(1R,2S,5R)-5-methyl-2-propan-2-ylcyclohexanecarbonyl]amino]acetate (CAS 68489-14-5; trade name: WS-5) and N-(2-hydroxy-2-phenylethyl)-2-isopropyl-5, 5-dimethylcyclohexane-1-carboxamide (trade name: Coolact® 370) and still further preferably the cooling agent is ethyl 2-[[(1R,2S,5R)-5-methyl-2-propan-2-ylcyclohexanecarbonyl]amino]acetate (CAS 68489-14-5; trade name: WS-5).

In each embodiment and preferred embodiment above, the cooling agent is preferably applied to the tipping paper and/or the outer surface of the filter material in an amount of 0.5 to 1.2 grams per square meter (gsm) and the menthol is contained in an amount of 0.10 to 0.60 wt % based on the total weight of the aerosol generating substrate.

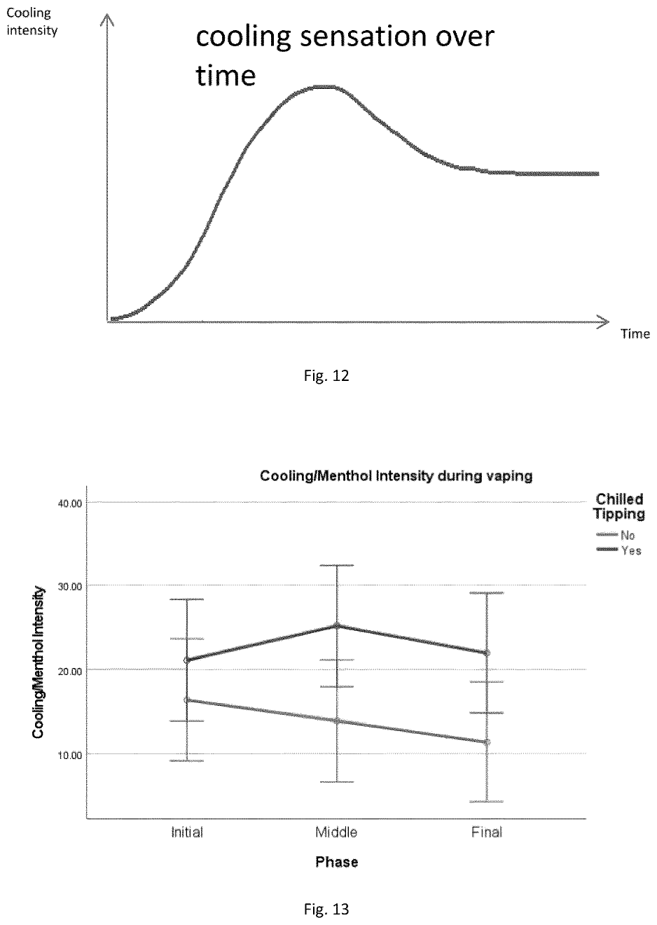

This cooling sensation of a vaping session is indicated in FIG. 12 and shows that the cooling sensation is provided quickly at a high level and, after a certain peak, is still provided at a pleasantly high level over the entire vaping session.

In order to verify the effect obtained by the invention, a trained panel of 16 assessors evaluated two heat sticks, i.e. aerosol generating articles with the same reconstituted tobacco blend and the same casing but differing by the presence of chilled tipping (the tipping paper being coated with cooling agent). 0.18% of menthol was present in the aerosol generating substrate of both sticks. WS-5 in an amount of 0.756 gsm was used as the cooling agent.

FIG. 13 was obtained by evaluating the cooling sensation in the initial first puff, then during the middle of the vaping session at around two and a half minutes and at the end of the vaping session at around four and a half minutes. The cooling intensity of both products was similar at the beginning of the vaping session as both have low levels of menthol applied to the blend. The perception is that of a tobacco flavour product with a slight refreshing sensation.

In the phase between the initiation of the vape and the middle of the vaping session, the inventors observed an important sensory difference between the product containing only menthol and the product containing the combination of menthol and the chilled tipping. The product with only menthol displays a decrease of the refreshing sensation and at the middle of the vaping session it is about 50% that provided by the product containing the combination of menthol and the chilled tipping. The product comprising the combination of menthol with the chilled tipping exhibited a different profile of the refreshing sensation. In particular, an important increase of the refreshing sensation is provided until the middle of the session. Then from the middle of the vape until the final puffs, the product with the chilled tipping provided a more stable cooling sensation to the user compared to the heat stick with no chilled tipping of which the cooling sensation decreased throughout the five minutes evaluation. In particular, at the end of the vaping session, with the product comprising the chilled tipping, the refreshing sensation is higher than the one observed during the initial puffs (i.e. the beginning of the vaping session), while the refreshing sensation with the product containing only menthol is lower than the one observed during the initial puffs (i.e. the beginning of the vaping session). The graph thus shows that the combination of the cooling agent with menthol provides a cooling and refreshing sensation which is maintained all along the session, compared to menthol alone, highlighting the synergistic effect of the combination.

1. An aerosol-generating article (10) comprising:
a first segment (12) located at a mouth end;
a second segment (16) comprising an aerosol generating substrate, and located upstream of the first segment (12);
optionally a third segment (18) for example comprising filter material, and located upstream of the second segment (16);
a cooling agent applied to at least a part of an outer surface of a tipping paper and/or impregnated into the filter material of the third segment (18) and/or applied to at least a part of an outer surface of the filter material of the third segment (18), and a flavouring agent applied to the aerosol-generating substrate, said flavouring agent comprising menthol.

2. The aerosol-generating article (10) of claim 1, wherein the cooling agent is not menthol.

3. The aerosol-generating article (10) of claim 1,
characterized in that the cooling agent is applied to the tipping paper and/or the outer surface of the filter material with an amount of 0.5 to 1.2 grams per square meter (gsm), preferably 0.7 to 0.8, more preferably 0.75 to 0.76 and most preferred about 0.756 gsm.

4. The aerosol-generating article (10) of claim 1,
characterized in that menthol is contained in an amount of 0.10 to 0.60 wt % based on the total weight of the aerosol generating substrate.

5. The aerosol-generating article (10) of claim 1, characterized in that menthol is contained in an amount of 0.10 to 0.25 wt % based on the total weight of the aerosol generating substrate.

6. The aerosol-generating article (10) of claim 1, characterized in that menthol is contained in an amount of 0.26 to 0.60 wt % based on the total weight of the aerosol generating substrate.

7. The aerosol-generating article (10) of claim 1, characterized in that the material provided in the third segment is a gathered paper sheet, such as used for paper filters.

8. The aerosol-generating article (10) of claim 7, characterized in that a paper based third segment is formed of crimped paper sheet material having a basis weight ranging from 20 to 50 gsm.

9. The aerosol-generating article (10) of claim 1, characterized in that the aerosol-generating substrate contains tobacco such as reconstituted tobacco, tobacco stems or a combination thereof, botanicals, in particular non-tobacco plant materials such as tea, rooibos, eucalyptus or the like, or a combination thereof.

10. The aerosol-generating article (10) of claim 1, characterized in that the first segment (12) comprise a filter material, preferably the filter material comprises cellulose acetate, paper or a non-woven cellulose-based material.

11. The aerosol-generating article (10) of claim 1, characterized in that a cooling segment (14) is provided between the first segment (12) and the second segment (16), preferably the cooling segment (14) is selected from the group consisting of a paper or cardboard tube or a center hole or a combination thereof.

12. The aerosol-generating article (10) of claim 1, characterized in that the cooling agent is applied to the tipping paper at least in an area from 5 and/or to 15 mm, preferably 10 mm from the mouth end of the aerosol-generating article (10).

13. The aerosol-generating article (10) of claim 1, characterized in that it is essentially cylindrical.

14. The aerosol-generating article (10) of claim 1, characterized in that the cooling agent is selected from the group consisting of: Cyclohexanecarboxamide, N-Ethyl-5-Methyl-2-(1-Methylethyl); N-(Ethoxycarbonylmethyl)-3-p-menthanecarboxamide; (1R,2S,5R)-N-(4-Methoxyphenyl)-5-methyl-2-(1-methylethyl)cyclohexanecarboxamide; Butanamide, N,2,3-trimethyl-2-(1-methylethyl); (N-Ethyl-2,2-diisopropylbutanamide; 1-[(1R,2R,4R)-2-hydroxy-4-methylcyclohexyl]ethenone; and N-(2-Hydroxy-2-phenylethyl)-2-isopropyl-5,5-dimethylcyclohexane-1-carboxamide);
preferably wherein the cooling agent is selected from the group consisting of: Cyclohexanecarboxamide, N-Ethyl-5-Methyl-2-(1-Methylethyl); N-(Ethoxycarbonylmethyl)-3-p-menthanecarboxamide; and N-(2-Hydroxy-2-phenylethyl)-2-isopropyl-5,5-dimethylcyclohexane-1-carboxamide);
still more preferably wherein the cooling agent is N-(Ethoxycarbonylmethyl)-3-p-menthanecarboxamide.

15. An aerosol-generating device comprising:
a heating chamber configured to receive therein at least a part of the aerosol-generating article (10) of claim 1;
a heating element (20) configured to heat the aerosol-generating article (10);
a power supply configured to supply power to the heating element (20).

16. A system comprising:
the aerosol-generating article of claim 1; and
an aerosol-generating device comprising:
a heating chamber configured to receive therein at least a part of the aerosol-generating article;
a heating element configured to heat the aerosol-generating article; and
a power supply configured to supply power to the heating element.
